(19) United States
(12) Patent Application Publication
(10) Pub. No.: US 2024/0144727 A1
(43) Pub. Date: May 2, 2024

(54) MULTIVIEW DEPTH-SENSING WEARABLE DEVICE

(71) Applicant: Carnegie Mellon University, Pittsburgh, PA (US)

(72) Inventors: Nathan Riopelle, Pittsburgh, PA (US); Christopher Harrison, Pittsburgh, PA (US)

(73) Assignee: Carnegie Mellon University, Pittsburgh, PA (US)

(21) Appl. No.: 18/384,673

(22) Filed: Oct. 27, 2023

Related U.S. Application Data
(60) Provisional application No. 63/419,804, filed on Oct. 27, 2022.

(51) Int. Cl. G06V 40/20; G06T 7/55

(52) U.S. Cl. CPC G06V 40/28; G06T 7/55; G06T 2207/10028

(57) ABSTRACT

A wearable device has a plurality of sensors surrounding a user's arm or wrist and provides depth information about the user's environment. Each sensor in the plurality of sensors has a field-of-view that may include the user's arm, torso, and surrounding environment. A controller receives data from the plurality of sensors and merges the data to create a composite image or depth point cloud. The device utilizes low-resolution sensors, with the composite image having a greater resolution and field-of-view than any individual sensor. The device is worn on the user's arm or wrist and can be used for static or continuous hand pose estimation, whole-arm pose estimation, and object detection, among other applications.

### CROSS-REFERENCE TO RELATED APPLICATIONS

This application claims the benefit under 35 U.S.C. § 119 of U.S. Provisional Application Ser. No. 63/419,804, filed on Oct. 27, 2022, which is incorporated herein by reference.

### STATEMENT REGARDING FEDERALLY SPONSORED RESEARCH

Not applicable.

### BACKGROUND OF THE INVENTION

The present disclosure generally relates to a wearable device capable of whole-arm tracking. More specifically, the disclosure relates to a wearable device that utilizes multiple depth sensors to locate a user in the environment and to identify arm and hand poses, among other capabilities.

Gesture and pose tracking for both the hands and arms have been long standing goals in the human-computer interaction field. In recent years with the advent of widespread smart wearables, there has been a great growth in interest in devices that can perform these types of tracking. At a basic level, gesture tracking can be used to augment existing devices such as smart-phones with an alternate input for interaction. Examples of this include zooming by pinching the index finger and thumb together or dismissing notifications with a flick of the wrist.

Systems with whole-arm tracking have also been shown to be capable of more complex forms of input such as recognizing in-air gestures for handwriting and mapping symbolic body language to emojis. One approach to gesture recognition is through indirect sensing of measurable features which indicate the presence of a gesture without ever imaging the shape of the body itself. Electromyography (EMG), which measures the electrical activity of muscle tissue, is one example of indirect gesture sensing. Many systems have implemented this technique because it is non-invasive and works consistently across a number of users. Similar techniques that also measure muscle activity include using air pressure bladders affixed to the forearm and resistive strain sensors on the wrist or back of hand. Other techniques for indirect sensing are tomography and electrical impedance tomography, which track gestures by emitting excitation signals into the forearm and measuring how the received signal changes based on shifts in the internal composition of the arm. Other system detect movement with inertial measurement units (IMUs) to track the user's arm in addition to the user's hand. Indirect sensing may not provide sufficient detail for complex applications.

Systems used for whole-arm tracking also include on-wrist systems which directly image the form of the hand or arm they are attempting to track. Within this category there are many different imaging sensors used. In the past, the two most popular have been arrays of IR emitters and detectors positioned around the wrist which capture one depth value per detector and single cameras mounted above the wrist of a variety of types including depth, thermal, active IR, and RGB cameras. Outside of these two, another common sensor class is ultrasonic transducers used for acoustic range finding. While often having superior signal-to-noise ratio due to direct tracking of the hand, a commonality of these systems is the need to operate significantly above the surface of the arm to achieve sufficient line of sight to the fingers. Even still, if the wrist bends away from the sensor, most of these systems will lose tracking due to occlusion.

Therefore, it would be advantageous to develop a device that can be worn on the wrist or arm and is capable of whole-arm tracking without occlusion problems or elevated and bulky sensors for use in a variety of complex applications.

### BRIEF SUMMARY

According to embodiments of the present disclosure is a wearable device that has a plurality of sensors capable of providing multiple views of the user's proximate environment, permitting tracking of a user's hand and arm. The sensors can be incorporated into a band or strap, such as a watch band, worn on a user's wrist. On the device are multiple depth sensors, each mounted at a different location and at multiple angles to image different features of interest, such as the hand, torso, or the user's environment. Each depth sensor is powerful and capable of imaging multiple views or depth values on its own, in essence acting as a miniature depth camera.

With the sensors of the device providing multiple views of the environment, the device may also provide information about a user's surroundings. Unlike prior systems, the sensors are not bulky and do not have to significantly protrude from the wrist or arm. The plurality of sensors limits the occlusion problem because the hand is likely to be in view of at least one sensor through many different hand movements. The device is capable of accurately identifying hand gestures, estimating hand pose, and estimating arm pose. This capability permits use of the device in many applications such as device control and data entry.

Another feature of the device is the ability to generate representative point clouds of the nearby environment, including features of interest such as walls, the floor, tables, and small objects. Using machine learning algorithms, these depth features are used in combination with data from an IMU collocated on the band to estimate the true pose of the user's hand and arm on the limb containing the device. The data provided by the device can be used in interactive applications, such as turning walls into touch screen by detecting touches, classifying small objects in front of the hand, and indoor location tracking.

### BRIEF DESCRIPTION OF THE SEVERAL VIEWS OF THE DRAWINGS

FIGS. 1A-1C show the wearable device, according to one embodiment, with the device being worn on a user's arm (FIGS. 1A-1B).

FIGS. 2A-2C depict the device with a rendering of the field-of-view of the sensors viewable.

FIG. 3 shows the device according to an embodiment with multiple rings of sensors positioned at different angles.

FIG. 4 is a series of images of different hand poses with the resulting point cloud captured by the device.

FIG. 5 shows hand poses with a corresponding depth map.

FIGS. 6A-6D are diagrams showing the relative angles of a first ring and second rings of sensors and the resulting point cloud generated by the device.

FIGS. 7A-7B shows a point cloud identifying an object in the environment (FIG. 7A) and an image of the objects (FIG. 7B) captured by the device in forming the point cloud.

FIG. 8 is an example of a point cloud of the user's environment.

### DETAILED DESCRIPTION

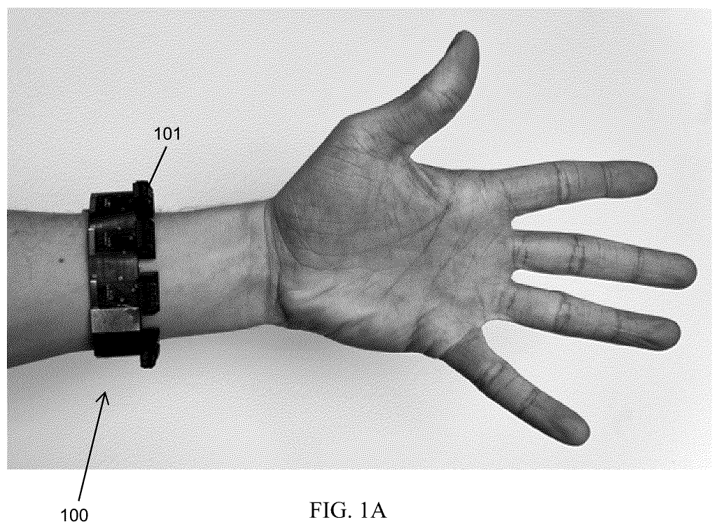

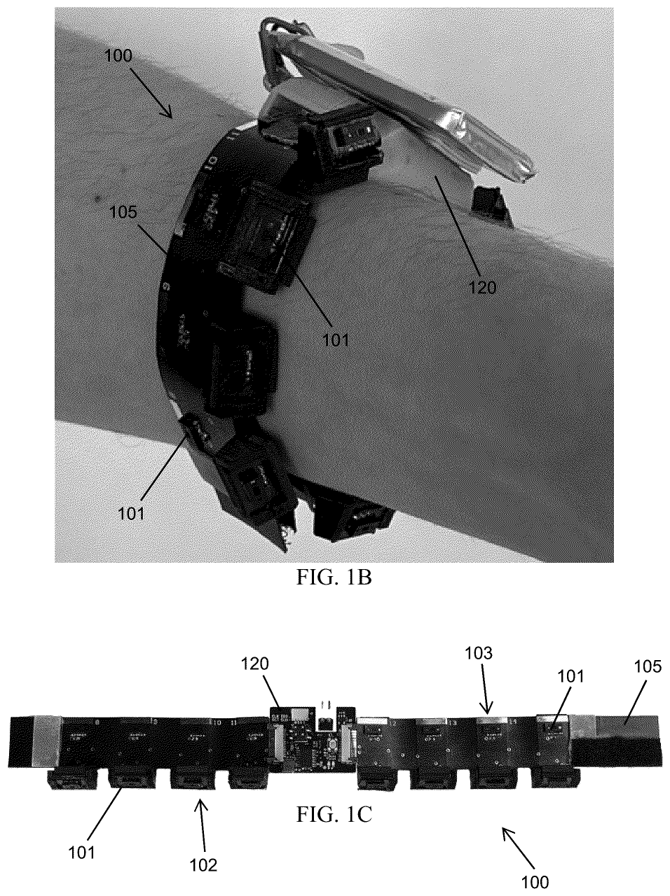

According to embodiments of the disclosure is a device 100 capable of being worn on a user's wrist or arm, where the device 100 provides information about the user's hand, arm, and/or environment. FIGS. 1A-1C show the device 100 with a plurality of sensors 101 embedded in a strap 105 which is adapted to be disposed circumferentially around the user's arm. The plurality of sensors 101 include at least 2 sensors that can be placed on opposite sides of the arm (i.e. palmar and dorsal surfaces) or at other locations. Additional sensors 101 can improve the performance of the device by preventing potential occlusion problems, which occurs when the hand is not visible by a sensor 101. For example, the embodiment shown in FIGS. 1A-1C includes 16 sensors 101. With 16 sensors 101, it would be difficult to have a hand pose that would not be visible to at least one sensor 101 of the plurality of sensors 101. The sensors 101 may include depth cameras, however other depth sensing technologies can be used, including sensors 101 utilizing time of flight, luminance/reflectance, ultrasonic, capacitive, and similar technologies.

With the decreasing costs of imaging sensors, some prior works utilized high resolution sensors. High resolution sensors tend to increase computational costs and could increase the difficulty in merging data from multiple sensors, if multiple sensors are used. In contrast, the present device 100 utilizes low-resolution sensors 101, such as those having a low pixel count, and combines the data from each sensor 101 into a composite image using a controller 120. The controller 120, which will be discussed in greater detail, receives data from each sensor 101 and merges the data to produce a composite image. Depending on the number of sensors 101, the composite image could have a field-of-view forming sphere or bubble around the user's wrist. The resolution and field-of-view of the composite image is greater than the resolution or field-of-view of any single sensor 101 of the plurality of sensors 101. By forming a composite image, the device 100 can utilize low-resolution sensors 101 to provide useful information about the user's environment, while decreasing the computational costs and size of the overall device 100. Using low-resolution sensors 101 may also improve framerate and power consumption. In one example embodiment, each sensor 101 is an 8×8 pixel imaging device. By way of further example, the low-resolution sensor 101 could range from one having a 1-pixel optical sensor to one with less than 1 megapixel.

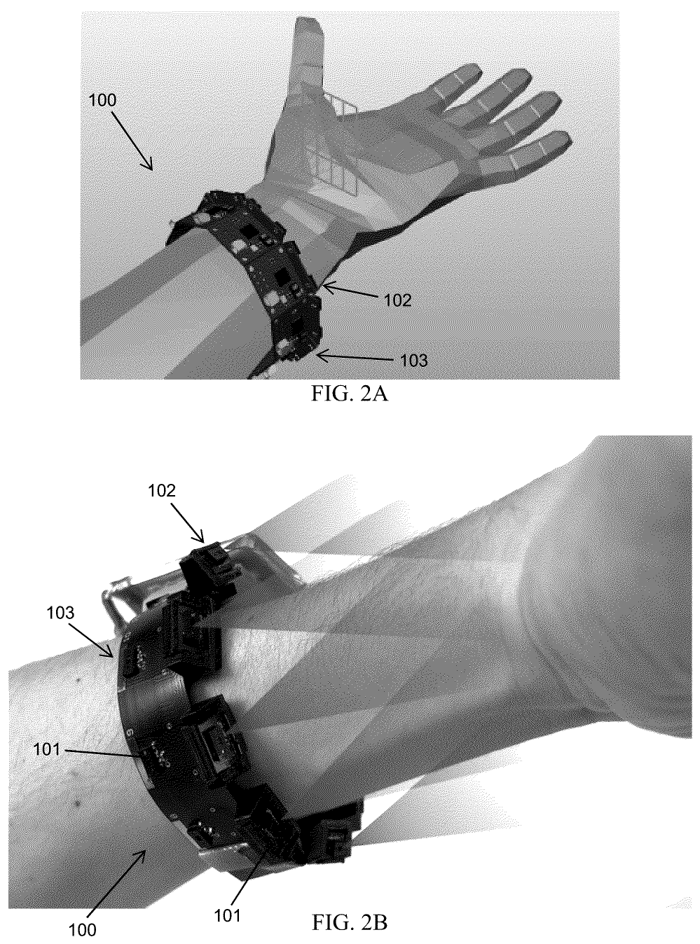

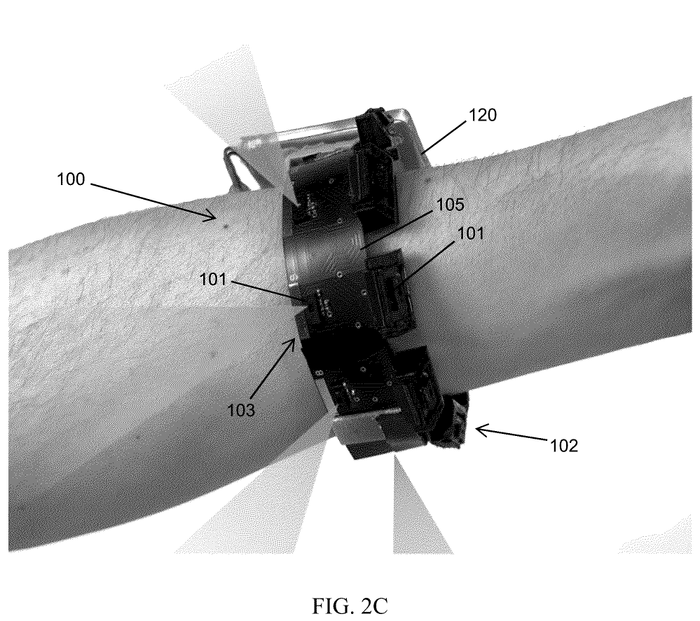

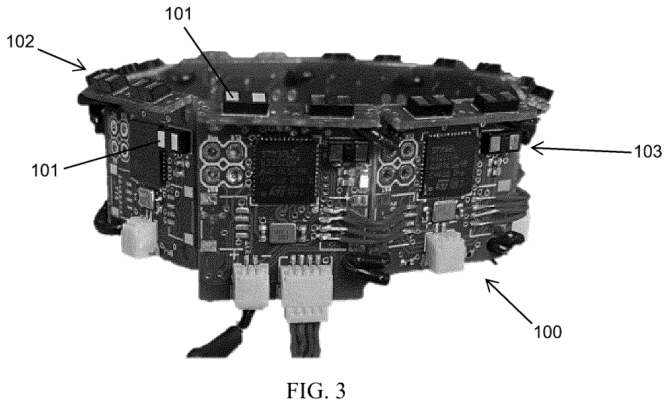

FIG. 2A shows the device 100 with the field-of-view of a single sensor 101 visible. The field-of-view of the sensor 101 in this example is facing the hand. The additional sensors 101 on the device 100 will have different fields-of-view, enabling the entirety of the hand to be imaged. Further, it is not required for the individual field-of-view shown in FIG. 2A to image the user's hand. There will be situations where the user's hand pose prevents this sensor 101 from imaging the hand. Rather, with multiple sensors 101, at least one sensor 101 of the plurality of sensors 101 will likely have a view of the hand. To increase the probability that the user's hand will be within the field-of-view of at least one sensor 101, the sensors 101 are arranged around the user's wrist or arm with different angles relative to the user. For example, FIGS. 2B-2C show the field-of-view of a first ring 102 of sensors 101 (FIG. 2B) and the field-of-view of a second ring 103 of sensors 101 (FIG. 2C), each on the same device 100. The first ring 102 of sensors 101 is mounted at an angle of 20 degrees to obtain data about the user's hand. With an angle of 20 degrees, the palm and back of the hand occupy less of the field-of-view of each sensor 101. While 20 degrees is used in this example, the angle can range from 0-90 degrees for each sensor 101. The second ring 103 of sensors 101 are mounted at an angle of 90 degrees to obtain data about the user's proximate environment, which could include the user's torso. Of note, the field-of-view in FIGS. 2A-2C is shown for illustrative purposes but would not normally be observable by a user. In other embodiments, such as the one shown in FIG. 3, the sensors 101 are distributed around the periphery of the user's wrist with equal spacing between adjacent sensors 101. However, non-equal distribution and/or spacing could be used while still creating a usable array of sensors 101.

In the example embodiment shown in FIG. 1C, the device 100 comprises two flexible printed circuit board (PCB) ‘wings’ that permit the device to be closely wrapped around a user's wrist, emulating a smartwatch strap. The implementation of the device 100 shown in FIG. 1C shows the flexible PCB over-molded in silicone. The sensors 101 in this example embodiment comprise time-of-flight ranging sensors (STMicroelectronics VL53L5CX). The surface-mount sensor 101 is able to capture an 8×8 depth image at 15 frames per second up to a range of 4 meters, allowing the device 100 to capture the proximate environment. This sensor 101 uses a 940 nm class 1 laser, which is eye safe. Each of these sensors 101 in a first ring 102 of sensors 101 is mounted perpendicular to the user's skin and has a 45 degree horizontal field-of-view, so that together, the sensors 101 provide a 360 degree point cloud 130. A second ring 103 of sensors 101 faces towards the user's hand (i.e., parallel to the skin). The sensors 101 in the second row 103 can have overlapping fields-of-view, but because they operate from different vantage points, they are able to image parts of the hand that might otherwise be occluded in other sensor views.

The device 100 includes a controller 120 to receive and process the data gathered by the plurality of sensors 101. The controller 120 may comprise a microcomputer, a microprocessor, a microcontroller, an application specific integrated circuit, a programmable logic array, a logic device, an arithmetic logic unit, a digital signal processor, or another data processor and supporting electronic hardware and software. As previously noted, the controller 120 aggregates the sensor data into a composite image, which may comprise a unified point cloud 130. In one embodiment, the controller 120 is a microcontroller connected to the sensors 101. The controller 120 may include an inertial measurement unit (IMU) that provides three axis inertial data, absolute orientation, and a magnetometer, which can provide additional data for determining the arm and/or hand pose of the user. The controller 120 may further include a battery connection, USB or Bluetooth communications, memory, and analog power circuitry for the sensors 101.

The controller 120 handles several responsibilities, including interfacing with the depth sensors 101, packaging data frames, and further processing the data. Processing can include creating 3D point clouds 130 from the data obtained from the sensors 101. Because the arrangement and positioning of the sensors 101 is relatively constrained, the position of each sensor 101 can be estimated. The position estimation is used by the controller 120 to composite all sensor data into the unified point cloud 130. This point cloud 130 can be oriented in three ways: aligned to the wrist's coordinate system (i.e. the device's first person point of view), rotated to align with the world using gravity and magnetic north vectors, and aligned to the wearer's upper body. The controller 120 can also implement basic signal filtering to reject outlier or intermittent noisy depth value to improve robustness.

By way of further detail, in one example embodiment, the controller 120 acquires data from all 16 depth sensors 101 (e.g. 8×8 pixel depth cameras) on the device 100. This frame of data is segmented and transformed into 16 8×8 arrays of depth values. Arrays may be flipped up/dawn or left/right depending on the orientation of the sensors 101. To accomplish this step of the process, 8×8 matrices are constructed that transform the 8×8 arrays of depth values into evenly-spaced rays on a spherical projection with a field-of-view matching the physical field-of-view of the sensor 101. Evenly-spaced rays are used when the sensors 101 are evenly-spaced on the device 100. With respect to matching the field-of-view with the physical field-of-view, the physical field-of-view may be oriented at 45 degrees from a line perpendicular to the device 100, which must be accounted for in the data. In the next step, all 16 of the 8×8 depth arrays are multiplied by the spherical projection matrices to transform the 2D depth images into 3D points. After this step, the data size is now 11.6×8×8×3 when using 8×8 pixel sensors 101. The projection matrices give each pixel the correct phi and theta angles on the spherical projection and the depth value is used as the r (magnitude) value. With the physical dimensions of the device 100 known, it can be determined how far apart each sensor 101 is from an adjacent sensor 101 and the angle of the field-of-view. Stated differently, the spacing relative to each other and the angle of the sensors 101 relative to the user's arm/wrist are parameters used in processing the data. This physical information can be used to create a series of functions which rotate and translate the 8×8 array of 3D points corresponding to each sensor 101 so that they align to the 3D position and rotation of the sensor 101 on the device 100. The physical-dimension matching functions are applied to the 16×8×8×3 3D data. The array dimensions of the rotated and translated 3D data are collapsed to get a single 1024×3 array that represents the 3D point cloud 130.

The resulting point cloud 130 generated by this process is shown in FIG. 4, which shows the device 100 worn by a user performing a variety of hand poses and the depth cloud 130 corresponding to the hand. More specifically, on the left side of FIG. 4 is the depth point cloud 130 generated from the data obtained by the sensors 101 imaging the hand and on the right side is the real-life hand pose. The ability of the point cloud 130 to capture hand pose in each position demonstrates the efficacy of depth sensors 101 for capturing continuous hand pose.

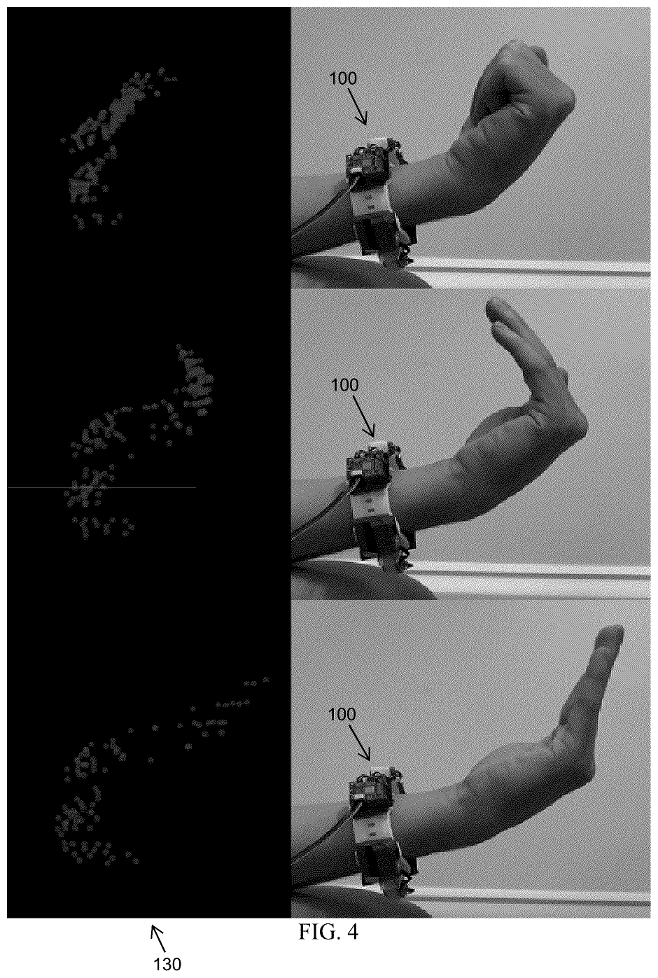

Unlike continuous hand pose detection, the device 100 can capture static hand poses with a depth map from a single sensor 101. For example, FIG. 5 shows a series of hand gestures with progressively more fingers being raised. On the left side of the image is the corresponding depth map from a single sensor 101 imaging the hand. With a plurality of sensors 101 on the device 100, at least one sensor 101 will likely have a field-of-view that includes the user's hand. As shown in FIG. 5, the single sensor 101 is capable of discern fine finger movements.

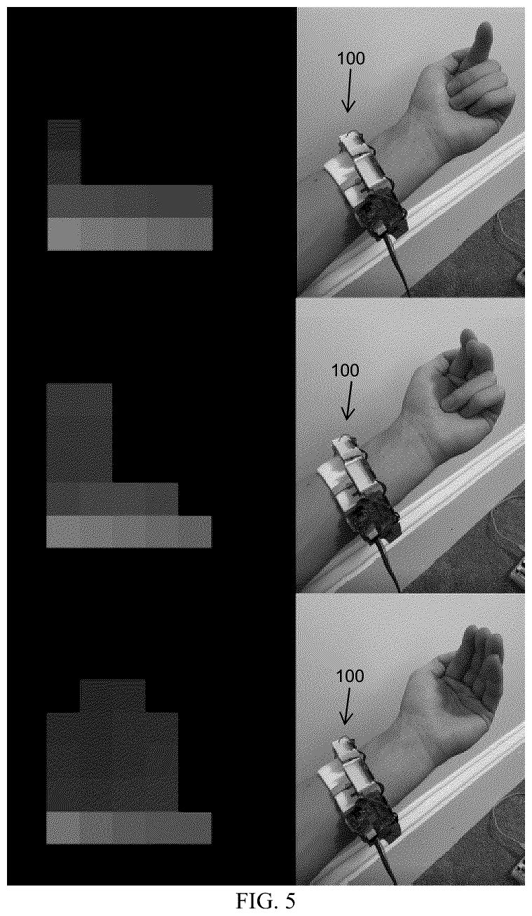

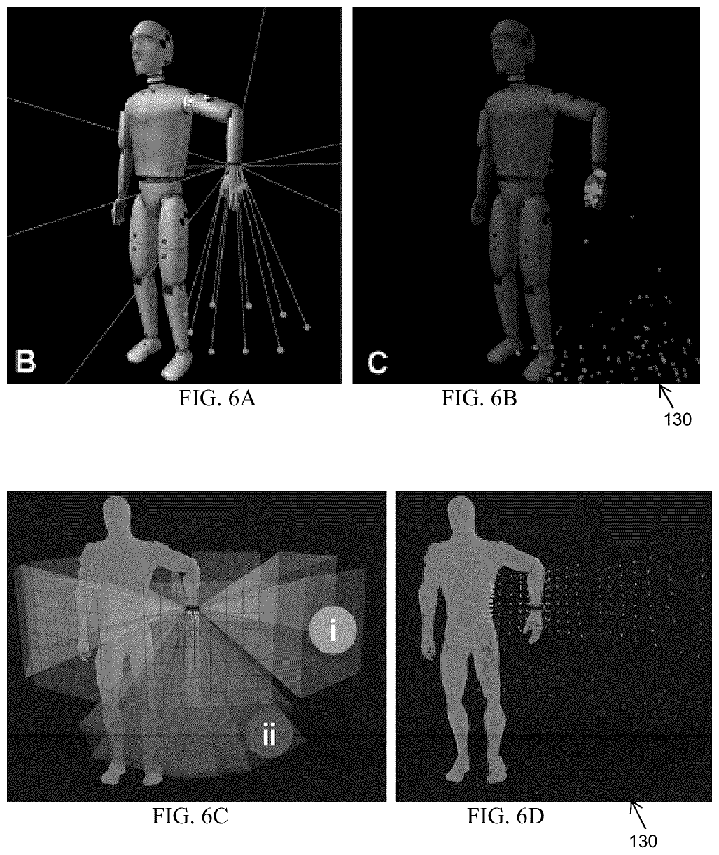

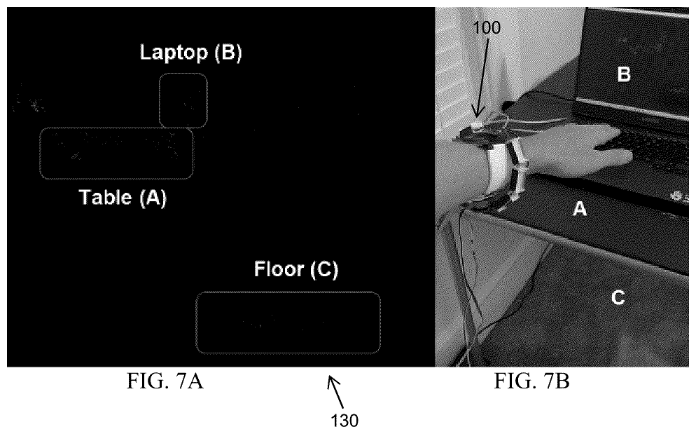

In addition to static and continuous hand pose identification, the device 100 is capable of arm pose capture. FIGS. 6A-6B shows the field-of-view of two rings 102/103 of depth sensors on the device 100. As shown in FIG. 6A, the first ring 102 of sensors has an angle of 20 degrees relative the arm of the user and the second ring 103 has an angle of 90 degrees. The first ring 102 faces the hand and will capture various surfaces of the hand. While many of the sensors 101 in this ring 102 capture the hand, several sensors 101 have a field-of-view that does not include the hand. The target of these sensors 101 will be the floor or a surface on which the user is standing, given the position of the hand pointing towards this surface. The second ring 103 of sensors 101 faces the body and surrounding environment. It is unlikely that this second ring 103 of sensors 101 will capture the hand as the field-of-view is pointed directly outward from the arm/wrist of the user. FIG. 6B depicts the resulting point cloud 130 captured by the device 100. Once the point cloud 130 is generated, arm pose can be estimated by finding the position of the device 100 relative to the torso and using an inverse kinematics solver. FIGS. 6C-6D are alternative views of the field-of-view of the sensors 101 (FIG. 6C) and the resulting point cloud 130 for the particular arm pose of the user.

In addition to hand and arm pose recognition, the device 100 can be used for a variety of other applications, including bimanual tracking, ad hoc touch tracking, object recognition, environment detection, and body scanning. In ad hoc touch tracking, the hand-facing sensors 101 not only capture the hand, but also objects and surfaces in front of the hand which can be appropriated for touch input. Surfaces can be identified by fitting a plane to the point cloud 130, if one exists. A ‘click’ could be detected by testing for a collision with the fitted plane at the tip of the user's finger. Object recognition could utilize the near-field point cloud 130 (e.g., less than 1 m from device 100). To increase object recognition performance, the distance and hand orientation could be used in connection with the point cloud 130 data.

As previously discussed, the device 100 can be used for static hand gesture recognition and can be further used to classify a predefined set of gestures. Once a gesture has been recognized, it can be used as a trigger for performing a virtual action. Examples of such gestures include swiping the hand to the left and right to advance pages in a digital document or pinching the thumb and index fingers together and rotating the wrist to adjust a virtual volume knob. In this application, gestures are determined by generating frames of data consisting of depth point cloud 130 data from the ring of sensors 102/103 parallel to the axis of the forearm and facing the hand. Once constructed, these data frames are then run through a machine learning (ML) classifier in the controller 120 that has been pre-trained on the desired set of recognizable hand gestures. Additional data from the on-board IMU can be used to turn a static gesture into a dynamic one. An example of this would be using a special static gesture (e.g., a fist) as a “wake gesture” to bring the system to attention, then detecting physical motions such as swiping to the left or right to perform a contextual action like skipping to a previous song or advancing a page in a document.

A related application of the device 100 is to provide continuous hand pose estimation. Unlike in the application of identifying static gestures, in continuous pose tracking, any movement of the fingers can be captured and estimated. The data fed into the controller 120 is the point cloud 130 of the depth values from the ring of sensors 102/103 facing the hand. In processing the data, this problem is fundamentally different from static gesture recognition in that instead of the ML model outputting a single, discrete value corresponding to a gesture class, the model will estimate the 3D position of each joint of the hand. By knowing the position of each joint, a visualization of the entire hand can then be constructed in a virtual environment. Potential uses of having a continuous model of hand pose include displaying a user's hands in virtual reality, mapping movements from a human hand to a robotic hand, and recognizing more complex hand interactions tasks such as typing.

Beyond just tracking the hand of the arm, the device 100 can also track the movements of that entire arm. This is accomplished by using the second ring 103 of sensors 101 facing perpendicular to the axis of the forearm and towards the body. By angling a sensor ring 103 away from the arm, the device 100 is able to capture a number of objects in close proximity to the arm. In this application the object of interest is the user's torso, which also should often be the closest large object sensed by the device 100. The first step in successful arm tracking is determining the 3D position of the end of the arm, which is where the device 100 is typically located. This is accomplished by determining the 3D position of the torso relative to the sensing device 100, then performing a transformation such that the torso is set as the origin of the 3D reference frame. After this transformation, the position of the device 100 relative to a fixed anchor point on the torso is known. To resolve any position ambiguities in the Z-dimension (up/down), the device 100 can use a gravity vector from its internal EMU to determine which way is down, and then measure the distance from the device 100 in the down direction to the floor, which can also be imaged by the body-facing sensing ring 103 of sensors 101. Once the position of the device 100 relative to the torso is finalized, inverse kinematics algorithms in the controller 120 can then be used to estimate the pose of the entire arm.

It should be noted that there exist instances where the device 100 may lose sight of the torso as the user moves their arm. Stated differently, no single sensor 101 in the plurality of sensors 101 has a field-of-view including the torso. In these moments, the device 100 will fall back on accelerometer and orientation data from its IMU to estimate the delta from the last known position until the torso can be re-locked. Applications of whole-arm tracking include rendering a user's arms in virtual reality, something very few current systems are able to accomplish, recognizing whole arm gestures like waving or pointing, and even analyzing form for strength training or physical therapy.

Although the device 100 can be used for hand and arm tracking, its sensing capabilities can also be utilized in a number of extended applications. When combined together, the data from the sensing rings 102/103 facing both the hand and body can create a holistic point cloud 130 of the entire environment around the user. Having a depth point cloud 130 of the nearby environment is useful for a number of different applications.

One example of this is turning any surface into an interactive touch screen, as previously discussed. By way of further example, one could imagine a user reaching out and touching a wall and having gestures such as tapping or moving their finger along a path translate to application tasks like clicking icons or creating shapes in a drawing program. While many existing touch sensors require instrumentation of the surface, the device 100 only requires instrumentation via a smartwatch strap or band 105 located on the user's personnel. This application can be accomplished by identifying planes within the environmental point cloud 130 and detecting when the user has touched one of these planes. Surfaces are detected by examining the individual planes of triads of points and using consensus methods to combine individual planes into those of larger objects like walls and tables. Once a surface touch is detected, the onboard MU can then be used to track the movement of the hand as it draws out a pattern until the hand is no longer touching the surface.

One useful outcome of the plane detection in the previous application is that the entire environmental point cloud 130 can be segmented into different regions. Examples of regions would include the hand itself, walls, the floor, the ceiling, and any other large surfaces like tables. When the points from each of these identified regions are taken out of the point cloud 130, all remaining points should correspond to any additional objects in the local environment.

Another application of the device 100 is determining the identity of these additional objects based on their size and shape in the depth point cloud 130. Identifying nearby objects is useful for a number of activity recognition scenarios. Such scenarios could include detecting when a user is reaching for a doorknob, when they are sitting in front of their laptop at their desk, or about to reach for a cup of coffee. Using the depth data already collected from its sensors 101, the device 100 can identify such scenarios by taking points in the object region and running them through a deep learning algorithm to estimate if the shape of any objects in the point cloud 130 matches with a known object, and can thereby be identified. FIGS. 7A-7B depicts a user wearing the device 100 approaching a table with a laptop on it and the floor visible in the field-of-view below the table. FIG. 7A is a visualization of the output environmental point cloud 130 in which clusters of points can be seen corresponding to each of the labeled features. FIG. 7B is an image with objects corresponding to the objects identified in the point cloud 130 of FIG. 7A.

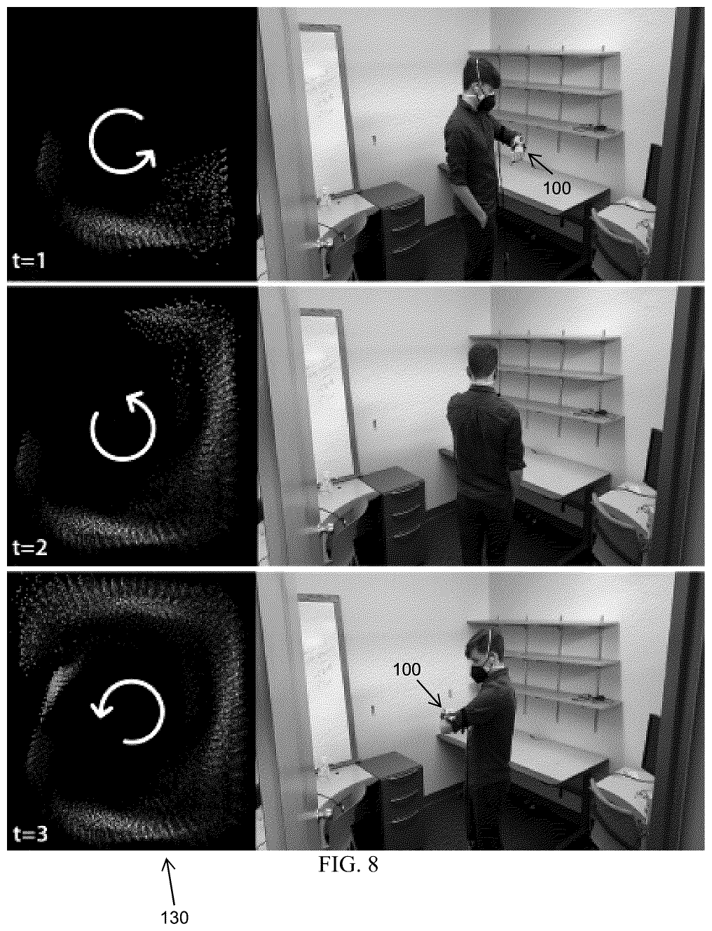

Another application of the environmental point clouds 130 generated by the device 100 is to construct a complete map of the user's local environmental geometry over time. This could be accomplished by taking the incoming point clouds 130 and running them through a simultaneous localization and mapping (SLAM) algorithm which will stitch each of the individual point clouds 130 together into a single large cloud. Though while standing in one spot, the point cloud 130 will only contain the geometry which is the band is able to image from that location, one could imagine a user wearing the device 100 throughout their day and building a complete map of their home or office. The main benefit of having a large point cloud 130 of a user's surroundings is enabling indoor localization on a finer scale than available with GPS or other current technologies. Fine-grained indoor localization can then be utilized in a number of different applications such as activity recognition by knowing when a user has entered a certain room like the kitchen, or elder care where caretakers may want to know when a user has fallen or left the house unattended. FIG. 8 is an example of the detection of the user's environment, with the resulting point cloud 130 shown on the left side of FIG. 8. In these series of images, the user turns and the device 100 captures the environment from a new vantage point. Thus, as the user turns, the device 100 builds a higher-resolution, multi-frame point cloud 130 of the environment. As shown in FIG. 8, even the ajar door is captured.

A final potential application of the device 100 involves analyzing the local point cloud 130 to detect when a user is walking, and if they encounter any obstacles or unique surfaces while moving. Using motion data from an IMU alone, many systems are already able to detect when a user is walking. However, in the absence of an INTU, this data can also be obtained from the point cloud 130. This is because while walking, in the point cloud 130, there will be a plane of depth points (the floor) seesawing back and forth as the user moves their arm. When combined with an onboard IMU, like on the device, finer grained gait analysis can be performed than possible with an IMU's motion data alone. Other unique advantages the point cloud 130 provides include detecting special surfaces the user encounters while walking such as ramps or stairs. Knowing this information could be helpful in an accessibility context where another application or piece of hardware is alerted to provide assistance to a user who has difficulty traversing these types of surfaces.

When used in this specification and claims, the terms “comprises” and “comprising” and variations thereof mean that the specified features, steps, or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure. Although certain example embodiments of the invention have been described, the scope of the appended claims is not intended to be limited solely to these embodiments. The claims are to be construed literally, purposively, and/or to encompass equivalents.

What is claimed is:

1. A device capable of being worn around a wrist or arm of a user, the device comprising:
a plurality of sensors having a field-of-view and adapted to be positioned circumferentially around the user's wrist or arm,
wherein the field-of-view of each sensor of the plurality of sensors is unique,
wherein the field-of-view includes at least one of the user's hand, torso, and immediate environment,
wherein each sensor comprises a low-resolution depth sensor providing depth data; and
a controller that receives the depth data and forms a composite depth image,
wherein the controller merges data from each sensor in the plurality of sensors to form the composite depth image,
wherein the composite depth image has a greater resolution and field-of-view than any single sensor of the plurality of sensors.

2. The device of claim 1, further comprising:
a strap adapted to circumferentially engage the user's arm or wrist,
wherein the plurality of sensors are disposed on the strap.

3. The device of claim 2, wherein the plurality of sensors are equally spaced around the strap.

4. The device of claim 1, wherein the field-of-view of the plurality of sensors comprises at least two angles relative to the user's arm.

5. The device of claim 1, wherein the plurality of sensors includes a first ring of sensors have a first field-of-view angle and a second ring of sensors having a second field-of-view angle.

6. The device of claim 5, wherein the first field-of-view angle and the second field-of-view angle are not equal.

7. The device of claim 5, wherein the first field-of-view angle is substantially 20 degrees and the second field-of-view angle is substantially 90 degrees.

8. The device of claim 1, wherein the low-resolution depth sensor comprises a sensor having a resolution of less than 1 megapixel.

9. The device of claim 1, wherein the low-resolution depth sensor comprises a sensor having a resolution between 1-pixel and 1 megapixel.

10. The device of claim 1, further comprising an inertial measurement unit,
wherein data received from the inertial measurement unit is combined with the composite image to determine a pose of the user's hand or arm.

11. The device of claim 1 wherein the plurality of sensors are positioned around a strap matching a circumference of the user's wrist,
wherein each sensor of the plurality of sensors is spaced apart from an adjacent sensor.

12. The device of claim 11, wherein each sensor of the plurality of sensors is equally spaced apart from the adjacent sensor.

13. The device of claim 1, wherein the controller transforms the composite depth image into a 3D point cloud.

14. The device of claim 13, wherein the controller transforms the composite depth image into the 3D point cloud based on a relative position of a sensor of the plurality of sensors and the field-of-view.

15. The device of claim 13, wherein the 3D point cloud is oriented in relationship to an orientation of the device on a user's wrist, to gravity, or to an upper body of the user.
